(19) United States
(12) Patent Application Publication
(10) Pub. No.: US 2006/0228560 A1
(43) Pub. Date: Oct. 12, 2006

(54) Photochromic optical article

(76) Inventors: Kevin J. Stewart, Murrysville, PA (US); Kevin W. Seybert, Pittsburgh, PA (US)

Correspondence Address: Deborah M. Altman;PPG Industries, Inc., One PPG Place, Pittsburgh, PA, 15272, US

(21) Appl. No.: 11/400,965

(22) Filed: Apr. 10, 2006

Related U.S. Application Data
(63) Continuation-in-part of application No. 10/793,498, filed on Mar. 4, 2004, now abandoned.

(51) Int. Cl. B32B 27/36

(52) U.S. Cl. 428/412

(57) ABSTRACT

Describes a photochromic article, e.g., an ophthalmic photochromic article, such as an ophthalmic lens, in which the article comprises, in combination, (1) a rigid substrate, such as a transparent thermoset or thermoplastic polymeric substrate, (2) a photochromic polymeric coating superposed on, e.g., appended to, at least a portion of at least one surface of the substrate, the photochromic polymeric coating containing a photochromic amount of at least one photochromic material, e.g., an organic photochromic material such as a spirooxazine, naphthopyran and/or fulgide, (3) a coating comprising a non-polarizing cross-linked polyhydroxy polymer, e.g., a poly(vinyl alcohol), appended to said photochromic polymeric coating, and (4) a further organic polymer layer that is superposed on said coating comprising a cross-linked polyhydroxy polymer. The aforedescribed photochromic article may also have an abrasion-resistant coating, e.g., a coating comprising an organo silane, affixed to the further organic polymer coating.

### CROSS-REFERENCE TO RELATED APPLICATIONS

This application is a continuation-in-part application of application Ser. No. 10/793,498 filed Mar. 4, 2004 for Photochromic Optical Article, which is incorporated herein by reference.

### FIELD OF THE INVENTION

The present invention relates to photochromic articles comprising a rigid substrate to which is applied a photochromic polymeric coating. In particular, the present invention relates to photochromic articles comprising a transparent rigid substrate, e.g., glass and organic plastic substrates used for optical applications, to which is applied a photochromic polymeric coating. More particularly, the present invention relates to photochromic articles used for ophthalmic applications, e.g., lenses.

### BACKGROUND OF THE INVENTION

Optical articles that provide good imaging qualities while reducing the transmission of incident light into the eye are needed for a variety of applications, such as sunglasses, vision correcting ophthalmic lenses, plano lenses and fashion lenses, e.g., non-prescription and prescription lenses, sport masks, face shields, goggles, visors camera lenses, windows, automotive windshields and aircraft and automotive transparencies, e.g., T-roofs, sidelights and backlights. Responsive to that need, photochromic plastic articles used for optical applications have been given considerable attention. In particular, photochromic ophthalmic plastic lenses have been of interest because of the weight advantage they offer, vis-à-vis, glass lenses.

Photochromic plastic articles have been prepared by incorporating the photochromic material into the plastic substrate by surface imbibition techniques. In this method, photochromic dyes are incorporated into the subsurface region of a plastic article, such as a lens, by first applying one or more photochromic dyes/compounds to the surface of the plastic article, either as the neat photochromic dye/compound or dissolved in a polymeric or other organic solvent carrier, and then applying heat to the coated surface to cause the photochromic dye/compound(s) to diffuse into the subsurface region of the plastic article (a process commonly referred to as “imbibition”). The plastic substrates of such photochromic plastic articles are considered to have sufficient free volume within the polymer matrix to allow photochromic compounds to transform from the colorless form into the colored form, and then revert to their original colorless form.

There are, however, certain polymer matrices that are considered not to have sufficient free volume to allow the aforedescribed electrocyclic mechanism to occur sufficiently to permit their use as a substrate for imbibed (or internally incorporated) photochromic materials for commercially acceptable photochromic applications. Non-limiting examples of such substrates include thermoset polymer matrices, such as those prepared from allyl diglycol carbonate monomers, e.g., diethylene glycol bis(allyl carbonate), and copolymers thereof; the commonly known thermoplastic bisphenol A-based polycarbonates; and highly cross-linked optical polymers.

To allow the use of thermoset polymers, thermoplastic polycarbonates, and highly cross-linked optical polymeric materials as plastic substrates for photochromic articles, it has been proposed to apply organic photochromic coatings to the surface of such plastic substrates. It has also been proposed to apply an abrasion-resistant coating onto the exposed surface of the photochromic coating to protect the surface of the photochromic coating from scratches and other similar cosmetic defects resulting from physical handling, cleaning and exposure of the photochromic coating to the environment.

In certain circumstances involving ophthalmic plastic lenses having a photochromic polymeric coating, it has been observed that the photochromic material within the polymeric coating migrates out of the polymeric coating and into an adjacent superposed layer placed on top of the photochromic polymeric coating. In some instances, the superposed layer is an abrasion resistant coating, while in other instances the superposed layer is a transparent organic polymer. It is desirable, therefore, to limit such migration of photochromic material from such a photochromic coating.

### BRIEF SUMMARY OF THE INVENTION

In a non-limiting embodiment of the present invention, there is provided a photochromic article comprising a rigid substrate, a photochromic organic polymeric coating appended to at least a portion of at least one surface of the substrate, the photochromic coating comprising a photochromic amount of at least one photochromic material, a coating or film comprising unstretched cross-linked polyhydroxy polymer superposed on, e.g., appended to, the photochromic organic polymeric coating, and a layer of transparent further organic polymer layer that is superposed on the cross-linked polyhydroxy polymer coating/film.

In a further non-limiting embodiment of the present invention, an abrasion resistant coating is superposed on, e.g., appended to, the transparent further organic polymer layer. In another non-limiting embodiment of the present invention, an antireflective coating is superposed on, e.g., appended to, the abrasion resistant coating. In a still further non-limiting embodiment of the present invention, at least one additional layer (coating/film) can be applied to the antireflective coating or to the abrasion resistant coating in place of or below the antireflective coating to provide further functional properties to the photochromic article, e.g., antistatic, polarizing and/or anti-wetting coatings.

In an alternate non-limiting embodiment of the present invention, there is provided a photochromic article comprising a rigid transparent substrate, e.g., a transparent organic polymeric substrate used for ophthalmic applications, a photochromic organic polymeric coating appended to at least a portion of at least one surface of the substrate, the photochromic coating comprising a photochromic amount of at least one organic photochromic material, a coating or film comprising unstretched cross-linked polyhydroxy polymer appended to the photochromic organic polymeric coating, the polyhydroxy polymer being substantially free of oriented polarizing materials, e.g., iodine and dichroic dyes, and a layer comprising a transparent further organic thermoset or thermoplastic polymer appended to the coating/film comprising the polyhydroxy polymer.

### DETAILED DESCRIPTION OF THE INVENTION

For purposes of this specification (other than in the operating examples), unless otherwise indicated, all numbers expressing quantities and ranges of ingredients, reaction conditions, etc., such as those expressing refractive indices and wavelengths, that are used in the following description and claims are to be understood as modified in all instances by the term “about”. Accordingly, unless indicated to the contrary, the numerical parameters set forth in this specification and attached claims are approximations that can vary depending upon the desired properties sought for the articles of the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

Notwithstanding that the numerical ranges and parameters setting forth the broad scope of the invention are approximations, numerical values set forth in specific examples are reported as precisely as possible. Any numerical value, however, inherently contains certain errors necessarily resulting from the standard deviation found in their respective testing measurements. Also, it should be understood that any numerical range recited herein is intended to include all sub-ranges subsumed therein. For example, a range “1 to 10” is intended to include all sub-ranges between and including the recited minimum value of 1 and the recited maximum value of 10; namely, a range having a minimum value equal to or greater than 1 and a maximum value of equal to or less than 10. Because the disclosed ranges are continuous, they include every value between the minimum and maximum values. Unless expressly indicated otherwise, the various numerical ranges specified in this application are, as stated, approximations.

As used in the following description and claims, the following terms have the indicated meanings:

The terms “acrylic” and “acrylate” are used interchangeably (unless to do so would alter the intended meaning) and include acrylic acid, lower alkyl-substituted acrylic acids, e.g., C₁-C₅ substituted acrylic acids, such as methacrylic acid, ethacrylic acid, etc, and derivatives of such acrylic acids, such as their C₁-C₅ alkyl esters, e.g., methyl acrylate, methyl methacrylate, etc., unless clearly indicated otherwise. The terms “(meth)acrylic” or “(meth)acrylate” are intended to cover both the acrylic/acrylate and methacrylic/methacrylate forms of the indicated material, e.g., a (meth)acrylic monomer.

The term “cure”, “cured” or similar terms, as used in connection with a cured or curable composition, e.g., a “cured composition” of some specific description is intended to mean that at least a portion of the polymerizable and/or crosslinkable components that form the curable composition are at least partially polymerized and/or cross-linked. In a non-limiting embodiment, the degree of crosslinking can range from 5% to 100% of complete crosslinking. In alternate non-limiting embodiments, the degree of crosslinking can range from 35% to 85%, e.g., 50 to 85%, of full crosslinking. The degree of crosslinking can range between any combination of the previously stated values, inclusive of the recited values.

The term “film”, as used in connection with the unstretched cross-linked polyhydroxy polymer, means and includes a layer that may be described either as a film or coating. The coating or film of unstretched cross-linked polyhydroxy polymer has a thickness within the range of thicknesses specified in the specification. The coating or film is also referred to herein as a coating/film.

The terms “on”, “appended to”, “affixed to”, “bonded to”, “adhered to” or terms of like import means that the subject coating, film or layer is either directly connected to (superimposed on) the object surface, or indirectly connected to the object surface through one or more other coatings, films or layers (superposed on).

The term “ophthalmic” refers to elements and articles that are associated with the eye and vision, such as but not limited to lenses for eyewear, e.g., corrective and non-corrective lenses, and magnifying lenses.

The term “rigid”, as used for example in connection with a substrate for a photochromic article, means that the specified item is self supporting.

The term “optical”, “optically clear”, or terms of like import means that the specified material, e.g., substrate, film, coating, etc., exhibits a light transmission value (transmits incident light) of at least 4 percent, and exhibits a haze value of less than 1 percent, e.g., a haze value of less than 0.5 percent, when measured at 550 nanometers by, for example, a Haze Gard Plus Instrument.

The term “polarizing material” means a material that absorbs one of two orthogonal plane-polarized components of transmitted radiation more strongly than the other. Non-limiting embodiments of polarizing materials include iodine, iodates, dichroic materials such as indigoids, thioindigoids, merocyanines, indans, azo and poly(azo) dyes, benzoquinones, naphthoquinones, anthraquinones, (poly)anthraquinones, and anthrapyrimidinones.

The term “substrate”, as used for example in connection with the term rigid substrate, means an article having at least one surface that is capable of accommodating a photochromic coating, e.g., a photochromic polymeric coating; namely, the substrate has a surface to which a photochromic coating can be applied. Non-limiting embodiments of the shape the surface of the substrate can have include, round, flat, cylindrical, spherical, planar, substantially planar, plano-concave and/or plano-convex, curved, including but not limited to, convex and/or concave, as exemplified by the various base curves used for ophthalmic lenses.

The term “transparent”, as used for example in connection with a substrate, film, material and/or coating, means that the indicated substrate, coating, film and/or material has the property of transmitting light without appreciable scattering so that objects lying beyond are seen clearly.

In accordance with one non-limiting embodiment of the present invention, a coating/film of unstretched cross-linked polyhydroxy polymeric material is superposed, e.g., superimposed, on a photochromic polymeric coating that is appended to at least a portion of at least one surface of a rigid substrate. A layer of transparent further organic polymer may be superposed on the unstretched cross-linked polyhydroxy polymer film. It has been discovered that superposing a coating/film of unstretched cross-linked polyhydroxy polymer film on the photochromic polymeric coating can substantially attenuate the migration of photochromic material from the photochromic polymeric coating and into a superposed coating, such as a coating of an organic polymer.

Polyhydroxy polymers used as the source of the coating/film are available commercially and can be natural materials, chemically modified natural materials, and/or synthetic materials. Among the natural materials that may be used are the natural water-soluble resins, such as agar (CAS 9002-18-0), carragenan (CAS 9000-07-1), guar gum (CAS 9000-30-0), gum arabic (CAS 9000-01-5), gum karaya (CAS 9000-36-6), locust bean gum (CAS 9000-40-2), gum traganth (CAS 9000-65-1), polysaccharides, such as potato, wheat, and rice starches (CAS 9005-25-8), tapioca (CAS 9005-25-8), corn starch (9005-25-8), and cellulose. Chemically modified natural materials include cellulose derivatives such as methyl cellulose (CAS 9004-67-5), sodium carboxy methyl cellulose (CAS 9004-32-4), hydroxyalkyl cellulose, such as hydroxyethyl and hydroxypropyl cellulose (CAS 9004-62-0 and 9004-64-2), cationic starch, e.g., aminoalkyl starch (CAS 9043-45-2), dextran (CAS 9004-54-0) and xanthan gum (CAS 11138-66-2).

Among the synthetic polyhydroxy polymers that may be used, there can be mentioned polymers prepared from hydroxy-containing ethylenic monomers, such as 2-hydroxyethyl methacrylate, 2-hydroxypropyl acrylate, 2-hydroxypropyl methacrylate, 2,4-dihydroxy-4-vinyl benzophenone, N-2-hydroxyethyl acrylamide, N-2-hydroxyethyl methacrylamide, and polyvinyl alcohols (CAS 9002-89-5), which are prepared by hydrolysis of poly(vinyl acetate). Polyvinyl alcohols are commercially available and in a non-limiting embodiment are used as the coating/film that is superposed on the photochromic polymeric coating. Commercially, and as used in this description and the accompanying claims, the term “polyvinyl alcohol” includes all water-soluble resins made from poly(vinyl acetate). Among the commercial polyvinyl alcohols, there can be mentioned those materials available under the trademarks ELVANOL, VINOL, GELVATOL and CELVOL.

A wide range of grades of polyvinyl alcohols are available commercially and include grades that are a fully hydrolyzed form of poly(vinyl acetate) and grades containing residual, e.g., unhydrolyzed acetate groups. There are three commercially significant types of polyvinyl alcohol (PVA) and these types are distinguished by the mole percent of residual (unhydrolyzed) acetate groups in the resin, e.g., fully hydrolyzed (1-2 mole percent), intermediate hydrolyzed (3-7 mole percent), and partially hydrolyzed (10-15 mole percent). PVAs with other degrees of hydrolysis are commercially available, but are not as commercially significant.

The physical properties of polyvinyl alcohols will vary according to the molecular weight of the parent poly(vinyl acetate) and the degree of hydrolysis. The degree of hydrolysis typically ranges from 72 to 98 or 99.8%. In one non-limiting embodiment, the degree of hydrolysis for the PVA is at least 87%. The degree of hydrolysis affects the temperature required to solubilize PVA in water. Lower temperatures are required as the degree of hydrolysis is decreased. A hydrolysis range of 87-89% is considered optimum for both cold and hot water solubility. The weight average molecular weight of polyvinyl alcohols can range from 3,000 to 190,000, more particularly, from 30,000 to 150,000, e.g., from 80,000 to 120,000.

Plasticizers may be added to polyvinyl alcohol in amounts up to 10 percent, e.g., from 1 to 7 percent. Water and polyhydroxy compounds, e.g., high boiling water-soluble organic compounds containing hydroxyl groups, are typically used as plasticizers for PVA films. Polyhydroxy compounds that may be used as a plasticizer include, but are not limited to, glycerol, ethylene glycol, poly(ethylene glycols) such as diethylene glycol and triethylene glycol, trimethylene glycol, tetramethylene glycol, pentamethylene glycol and hexamethylene glycol, propylene glycol, 2,3-butanediol, 1,3-butanediol, 2,2-dimethyl-1,3-butanediol, sorbitol, methylolated cyclic ethylene urea, and high boiling methylol compounds, such a pentaerythritol and 1,2,6-hexanetriol.

Crosslinking of polyvinyl alcohols insolubilizes and improves the water resistance and the mechanical properties of the PVA. Typically, bifunctional compounds that react with hydroxyl groups are used as crosslinking materials. Crosslinking materials that may be used include, but are not limited to, dimethylol urea, trimethylol melamine, low molecular weight dialdehydes, such as glyoxal and glutaraldehyde, urea-formaldehydes, melamine-formaldehydes, oxalic acid, diepoxides, polyacrolein, dialdehyde starch, divinyl sulfone, diisocyanates and organic titanates. Crosslinking of PVA can also be obtained when the parent poly(vinyl acetate) is cross-linked by irradiation and subsequently hydrolyzed. An acid catalyst, e.g., ammonium sulfate or ammonium chloride, is typically used with formaldehyde crosslinking materials.

Polyvinyl alcohol coatings/films and cross-linked PVA coatings/films are generally clear and transparent. The films are typically tough and have high tensile strength and abrasion resistance. Polyvinyl alcohol films and films from other synthetic, natural and chemically modified natural polyhydroxy polymers may be produced by solution casting or extrusion; however, film casting is most commonly used.

The cross-linked polyhydroxy polymer coating/film may be applied to the photochromic polymeric coating by any convenient means known to those skilled in the art, e.g., spin or spray coating, dip coating, etc. Non-limiting examples of such methods include preparing an aqueous solution comprising the polymer and cross-linking agent, applying a coating of the composition to the surface of the photochromic polymeric coating and curing the polyhydroxy polymer composition; and pre-forming a film of the cross-linked polyhydroxy polymer and affixing the pre-formed film to the photochromic polymeric coating.

The aqueous coating/film-forming composition comprising polyhydroxy polymer and cross-linking agent is affixed to the photochromic polymeric coating in a manner that results in a substantially uniform and homogenous coating/film. The thickness of the coating/film may vary. In alternate non-limiting embodiments, the coating/film thickness may vary from 0.1 micron to not more than 50 microns, e.g., from at least 0.5 micron to not more than 25 microns, such as from at least 1 micron to not more than 10 microns. The thickness of the cross-linked polyhydroxy polymer coating/film may range between any combinations of these values, inclusive of the recited values. For example, the cross-linked polyhydroxy polymer film may range from 0.1 to 10 microns.

Prior to applying the cross-linked polyhydroxy polymer coating/film to the photochromic polymeric coating, the photochromic coating may be treated to enhance adhesion of the polyhydroxy film to it. Non-limiting examples of such treatments include UV treatment, activated gas treatment, e.g., treatment with low temperature plasma or corona discharge, and chemical treatments that result in hydroxylation of the surface of the photochromic coating. Such treatments are discussed with respect to treatment of the rigid substrate, e.g., the organic polymer substrate, prior to applying the photochromic coating to the rigid substrate. That discussion is applicable also to the treatment of the photochromic coating to enhance adhesion of the polyhydroxy polymer film.

The relatively thin coating/film of cross-linked polyhydroxy polymer, e.g., polyvinyl alcohol, is an unstretched film. In contrast, polyvinyl alcohol sheets that are used to prepare polarizing filters are stretched in one direction to establish a grain within the PVA. In preparing polarizing filters, polarizing materials, e.g., dichroic dyes and iodine crystals, are incorporated into the stretched PVA sheet and line up, e.g., orient themselves, with the grain in a manner similar to the vanes of a venetian blind. The polarizing materials suspended within the PVA sheet absorb and filter reflected horizontal polarized light. In accordance with the present invention, since the polyhydroxy polymer coating/film superposed on the photochromic polymeric coating is unstretched, a grain within the polyhydroxy polymer coating/film is not established, and hence the polyhydroxy polymer coating/film is a non-polarizing coating/film. In a non-limiting embodiment of the present invention, the polyhydroxy polymer coating/film is substantially free of oriented polarizing materials such as dichroic dyes and iodine, e.g., iodine crystals.

Rigid substrates to which the photochromic polymeric coating is applied may vary and include any rigid substrate having at least one surface that will support a photochromic polymeric coating. Non-limiting examples of such rigid substrates include: paper, glass, ceramics, wood masonry, textiles, metals and organic polymeric materials. The particular substrate used will depend on the particular application that requires both a rigid substrate and a photochromic coating, which photochromic coating further requires the protection of a cross-linked polyhydroxy polymer film adjacent to the photochromic coating. In a non-limiting embodiment, the rigid substrate is transparent.

Polymeric substrates that may be used in preparing the photochromic articles of the present invention include organic polymeric materials and inorganic materials, such as glass. As used herein, the term “glass” is defined as being a polymeric substance, e.g., a polymeric silicate. Glass substrates may be of any type suitable for the intended purpose. In a non-limiting embodiment, the glass substrate is a clear, low colored, transparent glass such as the well-known silica type glass, particularly soda-lime-silica glass. The nature and composition of various silica glasses are well known in the art. The glass may be strengthened by either thermal or chemical tempering.

Polymeric organic substrates that may be used in preparing the photochromic articles of the present invention, are any of the currently known (or later discovered) plastic materials that are chemically compatible with the photochromic polymeric coating superposed on, e.g., applied to, the surface of the substrate. In a non-limiting embodiment, the polymeric organic substrate may be prepared from art-recognized polymers that are useful as optical substrates, e.g., organic optical resins that are used to prepare optically clear castings for optical applications, such as ophthalmic lenses.

Examples of organic substrates that can be used as polymeric organic substrates are polymers, e.g., homopolymers, oligomers and copolymers, including, but not limited to, substrates prepared from monomers and mixtures of monomers such as those disclosed from column 15, line 28 to column 16, line 17 of U.S. Pat. No. 5,658,501, which disclosure is incorporated herein by reference. Such organic substrates may be thermoplastic or thermoset polymeric substrates, e.g., transparent, more particularly, optically clear, substrates having a refractive index that desirably ranges from 1.48 to 1.74, e.g., 1.50 to 1.67.

Non-limiting examples of such disclosed monomers and polymers include: polyol(allyl carbonate) monomers, e.g., allyl diglycol carbonates such as diethylene glycol bis(allyl carbonate), which monomer is sold under the trademark CR-39 by PPG Industries, Inc; polyurea-polyurethane (polyurea urethane) polymers, such as the polymers described in U.S. Pat. No. 6,127,505 (column 2, line 26 to column 6, line 5, which disclosure is incorporated herein by reference), such polyurea-urethane polymers being prepared, for example, by the reaction of a polyurethane prepolymer and a diamine curing agent, a composition for one such polymer being sold under the trademark TRIVEX by PPG Industries, Inc; acrylic functional monomers, such as but not limited to, polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); poly(vinyl acetate); poly(vinyl alcohol); poly(vinyl chloride); poly(vinylidene chloride); polyethylene; polypropylene; polyurethanes; polythiourethanes, which include but are not limited to materials such as the MR-6, MR-7 and MR-8 optical resins from Mitsui Chemicals; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS; and polymers prepared by reacting polyfunctional isocyanate(s) and/or isothiocyanate(s) with polythiol(s) or polyepisulfide monomers, either homopolymerized or co-and/or terpolymerized with polythiols, polyisocyanates, polyisothiocyanates and optionally ethylenically unsaturated monomers or halogenated aromatic-containing vinyl monomers. Also contemplated are copolymers of such monomers and blends of the described polymers and copolymers with other polymers, e.g., to form interpenetrating network products. The organic polymeric substrate should be chemically compatible with the photochromic polymeric coating superposed on, e.g., applied to, the surface of the substrate. For optical applications, the substrate should be transparent.

The polymeric organic substrate used to prepare the photochromic articles of the present invention may have a protective coating, e.g., an abrasion resistant coating, on its surface. For example, commercially available thermoplastic polycarbonate optical lenses are typically sold with an abrasion-resistant coating, e.g., a hard coating, already applied to its surface(s) because the surface tends to be readily scratched, abraded or scuffed. A non-limiting example of such an article is a polycarbonate lens (available from Gentex Optics) that is sold with a hard coating already applied to the polycarbonate surface. As used in this disclosure and claims, the terms “polymeric organic substrate” (or similar terms) or “surface” of such a substrate, is intended to mean and include either the polymeric organic substrate itself or such a substrate with a coating, e.g., protective coating and/or primer, on the substrate. Thus, when reference is made in this disclosure or claims to applying a primer coating or photochromic polymeric coating to the surface of the substrate, such reference includes applying such a coating to the polymeric organic substrate per se or to a coating, e.g., an abrasion-resistant coating, on the surface of the substrate. Hence, the term “substrate” includes substrates having a coating on its surface. The coating may be any suitable coating (other than a photochromic coating) and is not limited to an abrasion-resistant coating (hard coat), e.g., any protective coating or other coating that provides one or more additional functional properties to the article of which the substrate is a part.

The use of photochromic organic coatings on plastic substrates, particularly plastic substrates such as thermoplastic polycarbonates, has been described. Any organic polymeric material that is compatible with the chosen organic substrate and which functions as a host material for the photochromic materials chosen for use may be used as the material for the photochromic organic coating. In a non-limiting embodiment, the host organic polymeric coating has sufficient internal free volume for the chosen photochromic material to function efficiently, e.g., to change from a colorless form to a colored form that is visible to the naked eye in response to ultraviolet (UV) radiation, and to change back to the colorless form when the UV radiation is removed.

Non-limiting examples of such organic polymeric materials include polyurethane-based coatings, such as those described in U.S. Pat. Nos. 6,107,395 and 6,187,444 B1 at column 3, line 4 to column 12, line 15, and International Publication WO 01/55269; polyurea urethane-based coatings as those described in U.S. Pat. No. 6,531,076 B2 at column 2, line 60 to column 10, line 49; epoxy resin-based coatings, such as those described in U.S. Pat. No. 6,268,055 B1 at column 2, line 63 to column 15, line 12; acrylic/methacrylic monomer-based coatings, such as those described in U.S. Pat. No. 6,602,603 at column 3, line 15 to column 7, line 50, U.S. Pat. No. 6,150,430 at column 8, lines 15-38, and U.S. Pat. No. 6,025,026 at column 8, line 66 to column 10, line 32; International Patent Publications WO 96/37593 and WO 97/06944, and U.S. Pat. Nos. 5,621,017 and 5,776,376; aminoplast, e.g., melamine type, resins, such as those described in U.S. Pat. Nos. 6,506,488 B13 at column 2, line 43 to column 12, line 23 and 6,432,544 B13 at column 2, line 52 to column 14, line 5; coatings comprising hydroxyl-functional components and polymeric anhydride-functional components, e.g., polyanhydride coatings, such as those described in U.S. Pat. No. 6,436,525 B1 at column 2, line 52 to column 11, line 60; and coatings comprising N-alkoxymethyl(meth)acrylamide functional polymers, such as those described in U.S. Pat. No. 6,060,001 at column 2, line 6 to column 5, line 40. The descriptions of the foregoing coating materials are incorporated herein by reference.

In alternate non-limiting embodiments, the photochromic organic polymer coatings may be chosen from photochromic polyurethane-based coatings, photochromic polyacrylic or polymethacrylic-based coatings [referred to collectively herein as poly(meth)acrylic-based coatings], photochromic polyurea urethane-based coatings, photochromic aminoplast resin-based coatings or photochromic epoxy resin-based coatings. In a non-limiting embodiment, the photochromic coating is an optically clear photochromic polyurethane, epoxy or poly(meth)acrylic-based coating.

Polyurethanes that may be used to prepare a photochromic polyurethane coating are those produced by the reaction of an organic polyol component and an isocyanate component, as more fully described in column 3, line 4 through column 6, line 22 of U.S. Pat. No. 6,187,444 B1, which disclosure is incorporated herein by reference. The relative amounts of the components comprising the polyurethane reaction mixture can be expressed as a ratio of the available number of reactive isocyanate groups to the available number of reactive hydroxyl groups, e.g., a ratio of NCO:OH groups of from 0.3:1.0 to 3.0:1.0. The isocyanate reactant may be an aliphatic, aromatic, cycloaliphatic or heterocyclic isocyanate, or mixtures of such isocyanates. In a non-limiting embodiment, the isocyanate reactant is chosen from blocked or unblocked aliphatic or cycloaliphatic isocyanates, or mixtures of such isocyanates.

Acrylic/methacrylic monomer-based polymer coatings, as described in the aforementioned U.S. Pat. No. 6,602,603, may be prepared from compositions comprising at least two difunctional (meth)acrylic monomers, which can have from greater than 3 to less than 15 alkoxy units. In one non-limiting embodiment, a difunctional (meth)acrylate has the reactive acrylate groups connected by a straight or branched chain alkylene group, which usually contains from 1 to 8 carbon atoms; while a second difunctional (meth)acrylate has the reactive acrylate groups connected by ethylene oxide, propylene oxide, butylene oxide or mixtures of such oxide groups in random or block order.

The epoxy resin-based coatings, as described in U.S. Pat. No. 6,268,055 B 1, may be prepared by the reaction of a composition comprising an epoxy resin or polyepoxide, e.g., polyglycidyl ethers of aliphatic alcohols and phenols, epoxy-containing acrylic polymers, polyglycidyl esters of polycarboxylic acids and mixtures of such epoxy-containing materials, with a curing agent, e.g., a polyacid comprising a half-ester formed from reacting an acid anhydride with an organic polyol.

Aminoplast resin-based coatings, as described in U.S. Pat. Nos. 6,432,544 B1 and 6,506,488, may be the reaction product of material(s) having at least two different functional groups chosen from hydroxyl, carbamate, urea or mixtures of such functional groups, and an aminoplast resin, e.g., a crosslinking agent. Materials having at least two different functional groups are described in the '444 patent from column 3, line 40 through column 12, line 23, which disclosure is incorporated herein by reference. An aminoplast resin is a condensation product of an amine or amide with an aldehyde, e.g., formaldehyde, acetaldehyde, crotonaldehyde, benzaldehyde and furfural. The amine or amide may be melamine, benzoguanamine, glycoluril, urea and similar compounds. Non-limiting examples of aminoplast resins are described in the '444 patent in column 12, lines 49 to 67, which disclosure is incorporated herein by reference.

The amount of photochromic polymeric coating applied to at least one surface of the plastic substrate is that amount which is sufficient to provide an amount of organic photochromic material that produces a coating exhibiting a desired change in optical density (ΔOD) when the cured coating is exposed to ultraviolet (UV) radiation, e.g., a photochromic amount. In a non-limiting embodiment, the change in optical density measured at 22° C. (72° F.) after 30 seconds of UV exposure is at least 0.05. In alternate non-limiting embodiment s, the change in optical density is at least 0.15, e.g., at least 0.20. In a non-limiting embodiment, the change in optical density after 15 minutes of UV exposure is at least 0.10. In alternate non-limiting embodiments, the change in optical density is at least 0.50, e.g., at least 0.70.

Stated alternatively, the amount of active photochromic material used in the photochromic coating may range from 0.5 to 40.0 weight percent, based on the total weight of monomer(s)/resin(s) used to produce the coating. The relative amounts of photochromic material(s) used can vary and will depend in part upon the relative intensities of the color of the activated form of the photochromic compound(s), the ultimate color desired, and the solubility or dispersibility of the photochromic material(s) in the polymeric coating. In a non-limiting embodiment, the concentration of active photochromic material(s) within the photochromic coating may range from 1.0 to 30 weight percent. In alternate non-limiting embodiments, the concentration of active photochromic material(s) within the photochromic coating may range from 3 to 20 weight percent, e.g., from 3 to 10 weight percent (based on the total weight of monomer(s) used to produce the coating.) The amount of photochromic material in the coating may range between any combinations of these values, inclusive of the recited values.

In a non-limiting embodiment, the photochromic coating applied to the surface of the rigid substrate will have a thickness of at least 3 microns. In alternate non-limiting embodiments, the thickness of the photochromic coating is at least 5 microns, such as at least 10 microns, e.g., 20 or 30 microns. In a non-limiting embodiment, the applied photochromic coating will also have a thickness of not more than 200 microns. In alternate non-limiting embodiments, the thickness of the photochromic coating is not more than 100 microns, such as not more than 50 microns, e.g., 40 microns. The thickness of the photochromic coating may range between any combinations of these values, inclusive of the recited values. For example, the thickness of the photochromic coating may range from 10 to 50 microns, e.g., 20 to 40 microns. In a non-limiting embodiment, the applied photochromic coating is free of cosmetic defects, such as scratches, pits, spots, cracks, inclusions, etc.

In coating parlance, the term “coating” is considered to be a layer having a thickness of not more than 4 mils (about 100 microns). However, as used in this specification and claims in relation to the photochromic coating, the term “coating” is used herein to mean a coating having a thickness within the range of thicknesses stated hereinabove.

Further, as used in this specification and claims, it is intended that the term “surface of the polymeric substrate” or like terms, e.g., the surface to which the photochromic polymeric coating is applied, includes an embodiment in which only a portion of the surface of the substrate is coated. Hence, the photochromic coating (and the further organic polymer layer that may be applied to the photochromic coating) may cover only a portion of at least one surface of the substrate. In a non-limiting embodiment, the photochromic coating is applied to cover the entire surface of the “at least one surface.”

In a non-limiting embodiment, the hardness of the cured photochromic polymer coating is sufficiently hard to be physically/mechanically handled without causing blemishes, e.g., scratches, on the coating. In one non-limiting embodiment, the hardness of the photochromic coating is less than the further organic polymer layer, which in turn is softer than an abrasion-resistant (hard coat) coating applied to the further organic polymer layer. The hardness of coatings or films may be quantified by tests known to the skilled artisan, e.g., Fischer microhardness, pencil hardness or Knoop hardness.

Photochromic materials, e.g., dyes/compounds or compositions containing such dye/compounds, that may be utilized for the photochromic coating applied to the rigid substrate are inorganic and/or organic photochromic compounds and/or substances containing such organic photochromic compounds that are currently known to those skilled in the art or that are later discovered. The particular photochromic material(s), e.g., compound(s), chosen will depend on the ultimate application of the photochromic article and the color or hue desired for that application. When two or more photochromic compounds are used in combination, they are generally chosen to complement one another to produce a desired color or hue.

Inorganic photochromic material typically contains crystallites of silver halide, cadmium halide and/or copper halide. Generally, the halide material is the chloride and bromide. Other inorganic photochromic materials may be prepared by the addition of europium (II) and/or cerium (III) to a mineral glass, such as a soda-silica glass.

Non-limiting examples of organic photochromic compounds that may be used in the photochromic polymer coating include benzopyrans, naphthopyrans, e.g., naphtho[1,2-b]pyrans, naphtho[2,1 -b]pyrans, spiro-9-fluoreno[1,2-b]pyrans, phenanthropyrans, quinopyrans, and indeno-fused naphthopyrans, such as those disclosed in U.S. Pat. No. 5,645,767 at column 1, line 10 to column 12, line 57 and in U.S. Pat. No. 5,658,501 at column 1, line 64 to column 13, line 36, which disclosures are incorporated herein by reference. Additional non-limiting examples of organic photochromic compounds that may be used include oxazines, such as benzoxazines, naphthoxazines, and spiro(indoline)pyridobenzoxazines. Other non-limiting examples of photochromic substances that may be used are photochromic metal dithizonates, e.g., mercury dithizonates; fulgides and fulgimides, e.g. the 3-furyl and 3-thienyl fulgides and fulgimides, which are described in U.S. Pat. No. 4,931,220 at column 20, line 5 through column 21, line 38, which disclosure is incorporated herein by reference; diarylethenes, which are described in U.S. Patent Application 2003/0174560 from paragraph [0025] to [0086], which disclosure is incorporated herein by reference; and mixtures of any of the aforementioned photochromic materials/compounds.

Further non-limiting examples of organic photochromic compounds, polymerizable photochromic compounds and complementary photochromic compounds are described in the following U.S. Patents:

U.S. Pat. No. 5,166,345 at column 3, line 36 to column 14, line 3;

U.S. Pat. No. 5,236,958 at column 1, line 45 to column 6, line 65;

U.S. Pat. No. 5,252,742 at column 1, line 45 to column 6, line 65;

U.S. Pat. No. 5,359,085 at column 5, line 25 to column 19, line 55;

U.S. Pat. No. 5,488,119 at column 1, line 29 to column 7, line 65;

U.S. Pat. No. 5,821,287 at column 3, line 5 to column 11, line 39;

U.S. Pat. No. 6,113,814 at column 2, line 23 to column 23, line 29;

U.S. Pat. No. 6,153,126 at column 2, line 18 to column 8, line 60;

U.S. Pat. No. 6,296,785 at column 2 line 47 to column 31, line 5;

U.S. Pat. No. 6,348,604 at column 3, line 26 to column 17, line 15; and

U.S. Pat. No. 6,353,102 at column 1, line 62 to column 11, line 64,

which disclosures are incorporated herein by reference.

The photochromic coating may contain one photochromic compound or a mixture of two or more photochromic compounds, as desired. Mixtures of photochromic compounds can be used to attain certain activated colors, such as a near neutral gray or near neutral brown. See, for example, U.S. Pat. No. 5,645,767, column 12, line 66 to column 13, line 19, which describes the parameters that define neutral gray and brown colors. Such disclosure is incorporated herein by reference.

The photochromic compound(s) described herein can be incorporated into the curable coating composition by addition to the coating composition and/or by dissolving it in a solvent before adding it to the curable coating composition. Alternatively, although less desired, the photochromic compound(s) can be incorporated into the cured polymer coating by imbibition, permeation, diffusion or other transfer methods, which methods are known to those skilled in the art of dye transfer into host materials.

In addition to the photochromic material, the photochromic polymer coating (or precursor formulation) may contain additional conventional adjuvants that impart desired properties or characteristics to the coating, or which are required by the process used to apply and cure the photochromic polymer coating on the surface of the plastic substrate, or which enhance the performance of the coating. Such adjuvants include, but are not limited to, ultraviolet light absorbers, light stabilizers, such as hindered amine light stabilizers (HALS), asymmetric diaryloxalamide (oxanilide) compounds, singlet oxygen quenchers, e.g., a nickel ion complex with an organic ligand, antioxidants, e.g., polyphenolic antioxidants, heat stabilizers, rheology control agents, leveling agents, e.g., surfactants, free radical scavengers, tinting agents, e.g., dyes, and adhesion promoting agents, such as trialkoxysilanes, e.g., silanes having an alkoxy radical of 1 to 4 carbon atoms, including γ-glycidoxypropyl trimethoxy silane, γ-aminopropyl trimethoxysilane, 3,4-epoxy cyclohexylethyl trimethoxysilane, dimethyldiethoxysilane, aminoethyl trimethoxysilane, and 3-(trimethoxysilyl)propyl methacrylate. Mixtures of such photochromic/coating performance enhancing adjuvant materials may be used.

The photochromic polymer coating composition may be applied to the surface of the rigid substrate as a polymerizable formulation and then cured (polymerized) by methods well known to those skilled in the art including, but not limited to, photopolymerization, thermal polymerization, and infrared polymerization. Such application methods include the art-recognized methods of spin coating, curtain coating, dip coating, spray coating or by methods used in preparing overlays. Such methods are described in U.S. Pat. No. 4,873,029.

When applied as a polymerizable formulation, the photochromic polymer coating formulation may also contain in one non-limiting embodiment from 0 to 10 weight percent, such as from 0.01 to 8 weight percent, e.g., from 0.1 to 5 weight percent, based on the total weight of the polymerizable monomer(s) in the formulation, of at least one catalyst and/or polymerization initiator, including photoinitiators. The amount of catalyst/initiator may range between any combinations of the aforestated values, inclusive of the recited values. The catalyst(s)/initiator(s) used are chosen from those materials that are used to polymerize the particular monomer(s) used to produce the polymeric coating chosen as the photochromic host, and that will not be significantly detrimental to the photochromic materials that can be included in the coating formulation. Generally, only that amount of catalyst/initiator that is required to initiate (catalyze) and sustain the polymerization reaction is used, e.g., an initiating or catalytic amount.

In a further non-limiting embodiment, the photochromic polymeric coating may be applied as a water-borne coating, e.g., as an aqueous polymer dispersion, with or without the presence of an organic solvent. This type of system is a two-phase system comprising an aqueous phase and an organic phase, which is dispersed in the aqueous phase. Use of water-borne coatings is well known in the art. See, for example, U.S. Pat. No. 5,728,769, which relates to aqueous urethane resins and coatings prepared from such resins, and the patents referred to in the '769 patent.

After the photochromic polymer coating formulation is applied to the surface of the plastic substrate, it is cured (polymerized) by the application of heat (in the case of a thermal cure), and/or ultraviolet or electron beam radiation. The specific cure conditions used will depend on the plastic substrate, the polymerizable components in the formulation and the type of catalyst/initiator used, or in the case of electron beam radiation, the intensity of the electron beam. Thermal curing may involve heating from room temperature up to temperatures below which the plastic substrate or photochromic material is not damaged due to such heating. Temperatures up to 200° C. have been reported. Such cure conditions are well known in the art. For example, a typical thermal cure cycle involves heating the formulation from room temperature (22° C.) to from 85 to 140° C. over a period of from 2 to 90 minutes. The time required for ultraviolet or electron beam radiation cures is generally shorter than a thermal cure, e.g., from 5 seconds to 5 minutes, and will depend on the intensity (power) of the radiation. When the thermal or UV/electron beam cure conditions produce a coating that can be physically handled but is not completely cured, an additional thermal post cure step can also be employed to fully cure the photochromic coating.

Prior to applying the photochromic polymer coating to the surface of the substrate to be covered, it is common to clean and treat that surface so as to enhance adhesion of the photochromic coating to the substrate. Non-limiting examples of cleansing methods include ultrasonic washing, washing with an aqueous soap/detergent solution (or washing with soap and water) followed by rinsing, and cleaning with an aqueous mixture of organic solvent, e.g., a 50:50 mixture of isopropanol/water or ethanol/water. Non-limiting examples of further treatments include UV treatment, activated gas treatment, e.g., treatment with low temperature plasma or corona discharge (using inert gas such as argon or a reactive gas such as oxygen), and chemical treatment that results in hydroxylation of the substrate surface, e.g., etching of the surface with an aqueous solution of alkali metal hydroxide, e.g., sodium or potassium hydroxide, which solution can also contain a fluorosurfactant. In a non-limiting embodiment, the alkali metal hydroxide solution is a dilute aqueous solution, e.g., from 5 to 40 weight percent alkali metal hydroxide. In alternate non-limiting embodiments, the concentration of the alkali metal hydroxide solution ranges from 10 to 15 weight percent, e.g., 12 weight percent. See, for example, U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials. Such disclosures are incorporated herein by reference.

In a non-limiting embodiment, a primer coating is applied to the plastic surface substrate before application of the photochromic coating. The primer may be applied to the rigid substrate by any of the methods used to apply the photochromic coating, e.g., spray, spin, spread, curtain, roll or dip coating; and can be applied to a cleaned and untreated or cleaned and treated, e.g., chemically treated, surface of the substrate. Primer coatings are well known to those skilled in the art.

In a non-limiting embodiment, the thickness of the primer coating may vary from one to several monomolecular layers. In alternate non-limiting embodiments, the thickness of the primer coating may range from 0.1 to 10 microns, e.g., from 0.1 to 2 or 3 microns. The thickness of the primer coating may vary between any combination of the aforementioned values, inclusive of the recited values. Non-limiting examples of primer coatings include coatings comprising an organofunctional silane, such as methacryloxypropyl trimethoxysilane, and coatings comprising a composition that is substantially free of organosiloxanes and which comprises organic anhydrides having at least one ethylenic linkage and an isocyanate-containing material.

In accordance with a non-limiting embodiment of the present invention, a further transparent polymer layer (coating or film), e.g., a tie layer, which typically is not photochromic, is superposed, e.g., superimposed on, the polyhydroxy polymer film. In a further non-limiting embodiment, the further polymer layer does not substantially interfere with the optical properties of an optical, e.g., ophthalmic, photochromic article prepared with the further transparent polymer layer. In alternate non-limiting embodiments, the further polymer layer is resistant to dilute aqueous inorganic caustic solutions, e.g., aqueous sodium and potassium hydroxide solutions, and is compatible with abrasion resistant coatings (if used) applied to the surface of the further organic polymer layer.

In a non-limiting embodiment of the present invention, the further transparent polymer layer is substantially free of photochromic material. The further transparent polymer layer may have an abrasion resistant coating superposed on it, and in turn an antireflective coating may be superposed on the abrasion resistant coating. The further transparent polymer layer can be referred to as a tie layer because of its location between the polyhydroxy polymer film and the abrasion resistant coating, and because in one non-limiting embodiment, it ties together the cross-linked polyhydroxy polymer film and the abrasion resistant coating.

Any curable monomeric composition that, when cured, is transparent and ties together the polyhydroxy polymer film and a superposed layer, e.g., the abrasion resistant coating or other film/coating that provides additional features, without adversely affecting the function of the films/layers that it ties together (including the photochromic coating), may be used as the further organic polymer layer. Non-limiting examples of such polymeric tie layers are described in International Patent Application WO 03/058300 A1 and WO 05/093467. The polymer tie layers described in said International Patent Application WO 03/058300 are radiation cured acrylic-based polymers that are described as (a) scratch resistant, (b) resistant to treatment with dilute aqueous inorganic caustic solutions, and (c) compatible with abrasion resistant, organo silane-containing coatings. The description of the radiation cured acrylic-based polymers in WO 03/058300 is incorporated herein by reference.

Other materials that may be used as the further transparent organic polymeric layer (tie layer) include, but are not limited to, (1) dendritic polyester acrylate-based coating layers, as described in U.S. patent publication, Serial No. 2005/0196617 A1 of E. King, filed on Mar. 4, 2004 and entitled “Photochromic Optical Article”; (2) cured coating layers prepared from compositions comprising a maleimide derivative, as described in U.S. patent publication, Serial No. 2005/0196696 A1 of E. King, filed on Mar. 4, 2004 and entitled “Photochromic Optical Article”; (3) thermally cured acrylic-based coatings; and (4) thermally cured, crosslinkable thermosetting coating compositions, such as polyurethane-based coatings, polyepoxide-based coatings, polysiloxane-based coatings, carbamate and/or urea-based coatings, aminoplast-based coatings, film-forming resin compositions comprising a latex emulsion that includes cross-linked polymeric micro particles dispersed in an aqueous continuous phase, and powder clear coatings, all as more fully described in U.S. patent publication, Serial No. 2005/0196618 A1 of C. Knox et al, filed on Mar. 4, 2004 and entitled “Photochromic Optical Article”. The disclosures of such materials in the aforementioned patent publications are incorporated herein by reference.

Acrylic-based polymer tie layers, such as the polymers described in WO 03/058300 A1, may be prepared using acrylic or methacrylic monomers or a mixture of acrylic and/or methacrylic monomers (hereinafter referred to collectively as (meth)acrylic monomers). The mixture of (meth)acrylic monomers may include mono-, di-, tri-, tetra-, and penta-acrylic functional monomers. Additional co-polymerizable monomers, such as epoxy monomers, e.g., monomers containing an epoxy functionality, monomers containing both acrylic and epoxy functionalities, etc., may also be present in the formulation used to prepare the acrylic-based polymer film, as described subsequently herein. The monomers used to prepare the acrylic-based polymer film are typically comprised of a plurality, e.g., a major amount, e.g., more than 50 weight percent, of acrylic-functional monomers; hence the designation “acrylic-based polymer film”. The formulations used to prepare the acrylic-based polymer film may also contain components having at least one isocyanate functionality, e.g., organic monoisocyanates and organic diisocyanates, thereby to incorporate polyurethane groups into the film.

Radiation-curable and thermally-curable acrylic-based polymeric systems are well known in the polymer art and any such system that meets the requirements described elsewhere herein for the photochromic article of the present invention may be used to produce the acrylic-based polymer tie layer. In a non-limiting embodiment of a radiation-curable composition for an acrylic-based polymer tie layer comprises a combination or miscible blend of one or more free-radical initiated acrylic monomers and/or acrylic oligomers, and one or more cationic initiated epoxy monomers. When this blend of monomers is cured, a polymerizate comprising an interpenetrating network of polymer components is produced.

Non-limiting examples of acrylic monomers include polyfunctional acrylates, e.g., di-, tri-, tetra-, and penta-functional acrylates, and monofunctional acrylates, e.g., a monomer containing a single acrylic functionality, hydroxy-substituted monoacrylates and alkoxysilyl alkylacrylates, such as trialkoxysilylpropylmethacrylate. Other reactive monomers/diluents, such as monomers containing an ethylenic functional group (other than the acrylic-functional materials) may also be present.

Many acrylic monomer materials may be represented by the following general formula II,
R—(OC(O)C(R′)═CH₂)ₙ II
wherein R is an aliphatic or aromatic group containing from 2 to 20 carbon atoms and optionally from 1 to 20 alkyleneoxy linkages; R′ is hydrogen or an alkyl group containing from 1 to 4 carbon atoms, and n is an integer of 1 to 5. When n is greater than 1, R is a linking group that links the acrylic functional groups together. Typically, R′ is hydrogen or methyl, and n is an integer of from 1 to 3. More specifically, diacrylates (when n is 2) can be represented by general formula III, 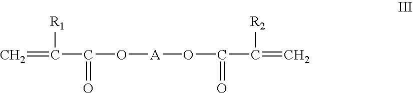
wherein R₁ and R₂ can be the same or different and are each chosen from hydrogen or alkyl groups containing from 1 to 4 carbon atoms, desirably hydrogen or methyl, and A is a hydrocarbyl linking group of, for example, from 1 to 20 carbon atoms, e.g., an alkylene group, one or more oxyalkylene group(s) [or mixture of different oxyalkylene groups]; or a group of the following general formula IV, 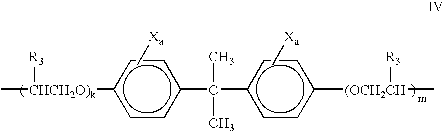
wherein each R₃ is a hydrogen atom or an alkyl group of from 1 to 4 carbon atoms, e.g., methyl; X is a halogen atom, e.g., chlorine; a is an integer of from 0 to 4, e.g., 0 to 1, representing the number of halogen atoms substituted on the benzene ring; and k and m are numbers of from 0 to 20, e.g., 1 to 15, or 2 to 10. The values of k and m are average numbers and when calculated can be a whole number or a fractional number.

Acrylic monomer materials having an epoxy group may be represented by the following general formula V, 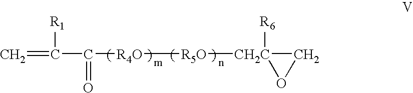
wherein R₁ and R₆ can be the same or different and are each chosen from hydrogen or an alkyl group of from 1 to 4 carbon atoms, e.g., methyl; R₄ and R₅ are alkylene groups containing from 2 to 3 carbon atoms, e.g., ethyleneoxy and propyleneoxy, and m and n are numbers of from 0 to 20, e.g., 0 or 1 to 15 or 2 to 10. When one of m and n is 0 and the other is 1, the remaining R group can be an aromatic group of the following formula VI, 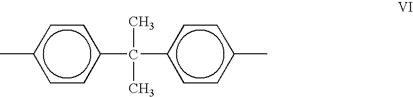
e.g., a group derived from the 2,2′-diphenylenepropane radical, which phenyl groups can be substituted with C₁ to C₄ alkyl groups or halogens, e.g., methyl and/or chlorine.

The amount, number and type of functional acrylates comprising the curable acrylic-based polymer formulation will vary and will depend on the physical properties of the further polymer layer that are most desired since, for example, varying the crosslink density of the polymer layer, e.g., by varying the amount of tri-functional acrylic or other cross-linking monomers used in the acrylic-based polymer tie layer formulation, will alter the final properties of the tie layer. It is generally accepted in the art that the cross-link density of a cured acrylic polymer film is a function of the amount of multifunctional acrylic monomer materials used. High amounts of multifunctional acrylic materials lead to high hardness, tensile strength and chemical resistance, but with poorer adhesion to the substrate. In contrast, reducing the amount of multifunctional acrylic materials and increasing the amount of monofunctional acrylic materials lead to a lower cross-link density of the cured polymer with consequent lower hardness, chemical resistance and tensile strength, and a slower cure speed. Therefore, one skilled in the art can vary the amounts of mono- and multi-functional acrylic monomers used depending on whether it is desirable to optimize adhesion, hardness (scratch resistance), chemical resistance, e.g., resistance to aqueous alkali metal hydroxide treatment, or other properties; or whether it is desirable to compromise one or more of these properties to obtain an average benefit for all of those physical properties. One skilled in the art can readily select the combination of monomeric materials to be used for the acrylic-based polymer tie layer based on the art-recognized benefits that certain functional groups provide to a cured acrylic polymer.

In a further non-limiting embodiment, the further organic polymer tie layer may be prepared from a composition comprising a mixture of free-radical initiated acrylic monomer(s) and cationic initiated epoxy monomer(s). The curable composition may comprise from 10 to 85 percent by weight of at least one epoxy monomer(s) and from 90 to 15 percent by weight of at least one acrylic monomer(s). In alternate non-limiting embodiments, the curable composition may comprise from 30 to 70 weight percent epoxy monomer(s) and from 70 to 30 weight percent acrylic monomer(s), e.g., from 35 to 50 weight percent epoxy monomer(s) and from 65 to 50 weight percent acrylic monomers. Monomers containing both epoxy and acrylic functionality are categorized herein as acrylic monomers. The amount of acrylic monomer and epoxy monomer in the curable composition described heretofore may vary between any combination of the stated values, inclusive of the stated values.

Epoxy monomers used in the polymer formulation are those monomers that are initiated by cationic initiators. In one non-limiting embodiment, the epoxy monomers are epoxy condensation polymers, such as polyglycidyl ethers of alcohols and phenols, and certain polyepoxy monomers and oligomers. The epoxy monomers improve adhesion of the cured polymer to the cross-linked polyhydroxy film and enhance other properties of the cured further organic polymer layer, such as improving the adhesion of an abrasion-resistant coating, e.g., a siloxane coating, to a cured acrylic-based polymer layer. Cured acrylic-based polymers prepared with epoxy monomers also appear to improve the abrasion resistance of the abrasion-resistant coating (hard coat), when used, that is applied to the further organic polymer layer and results also in less crazing of the antireflective coating (when used over the hard coat).

Epoxy monomers, e.g., monomers having at least one epoxy group in the molecule may be represented by the following general formula VII, 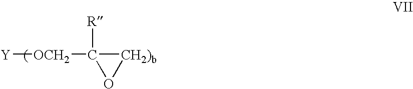
wherein Y is a residue of a b-valent alcoholic hydroxyl compound, a residue of a b-valent phenolic hydroxyl group-containing compound, or a residue of a b-valent carboxylic acid, R″ is a hydrogen atom or a methyl group, and b is an integer of from 1 to 4, typically 1 to 2. These materials include alcoholic hydroxyl group-containing compounds of monohydric dihydric or trihydric alcohols, reaction products between phenolic hydroxyl compounds, such as phenol and hydroquinone, and epichlorohydrin, and reaction products between carboxylic acids, such as benzoic acid and terephthalic acid, and epichlorohydrin.

Epoxy monomers represented by formula VII may also contain (as part of Y) a radical polymerizable group (other than acrylic) such as a vinyl group or an allyl group. Monomers containing an acrylic polymerizable group and an epoxy group are categorized herein with the acrylate monomer(s) previously described.

Non-limiting examples of epoxy monomer compounds having at least one epoxy group in the molecule and not having a polymerizable group include those of formula VII wherein b is 1 or 2. When b is 1, Y may be an alkyl group having from 2 to 20 carbon atoms, which can be substituted with a hydroxyl group; a cycloalkyl group having from 6 to 7 carbon atoms, which can be substituted by a hydroxyl group; a phenyl group, which can be substituted by a hydroxyl group; a benzoyl group, which can be substituted by a carboxyl group; or a hydroxyalkyleneoxy group. When b is 2, Y may be an alkylene group containing from 2 to 20 carbon atoms, which can be substituted by a hydroxyl group; a cycloalkylene group, which can be substituted by a hydroxyl group; a phenylene group, which can be substituted by a hydroxyl group; a phthaloyl group; an isophthaloyl group; a terephthaloyl group; a 2,2′-bisphenylene propyl group; and an alkyleneoxy group. The alkyleneoxy group may have from 1 to 20 alkyleneoxy groups, and the alkylene moiety may have from 2 to 4 carbon atoms.

Non-limiting examples of epoxy compounds include ethylene glycol glycidyl ether, propylene glycol glycidyl ether, 1,4-butanediol diglycidyl ether, glycerol polyglycidyl ether, diglycerol polyglycidyl ether, sorbitol polyglycidyl ether, butyl glycidyl ether, phenyl glycidyl ether, polyethylene glycol diglycidyl ether, polypropylene glycol diglycidyl ether, neopentyl glycol diglycidyl ether, 1,6-hexanediol diglycidyl ether, propylene carbonate, bisphenol A or hydrogenated bisphenol A propylene oxide adduct, diglycidyl ester of terephthalic acid, spiroglycol diglycidyl ether, hydroquinone diglycidyl ether and 3,4-epoxycyclohexane carboxylate.

Epoxy condensation polymers that may be used are polyepoxides having a 1,2-epoxy equivalency greater than 1, e.g., up to 3. Non-limiting examples of such epoxies are polyglycidyl ethers of polyhydric phenols and aliphatic (cyclic and alicyclic) alcohols. Non-limiting examples of suitable polyphenols are 2,2-bis(4-hydroxyphenyl)propane, e.g., bisphenol A, 1,1-bis(4-hydroxyphenyl)ethane, and 2-methyl-1,1-bis(4-hydroxyphenyl)propane. Non-limiting examples of aliphatic alcohols include ethylene glycol, diethylene glycol, 1,2-propylene glycol, 1,4-butylene glycol, 1,2-cyclohexanediol, 1,4-cyclohexanediol, 1,2-bis(hydroxymethyl)cyclohexane and hydrogenated bisphenol A. These epoxy materials are available from Resolution Performance Products under the EPON trade name.

Non-limiting examples of polyepoxide monomers and oligomers are described in U.S. Pat. No. 4,102,942 (column 3, lines 1-16), which disclosure is incorporated herein by reference. Specific examples of such polyepoxides are 3,4-epoxycyclohexylmethyl, 3,4-epoxycyclohexanecarboxylate and bis(3,4-epoxycyclohexylmethyl)adipate. Aliphatic polyepoxides are available from the Dow Corporation under the CYRACURE trade name.

Monomeric materials that may be used to prepare the further curable transparent polymer tie layer formulations are commercially available; and, if not commercially available, can be prepared by procedures well known to those skilled in the art. Non-limiting examples of commercial acrylic materials can be found in U.S. Pat. No. 5,910,375, particularly in the disclosure found in column 8, lines 20-55, and in column 10, lines 5-36, which disclosure is incorporated herein by reference. Commercially available acrylic materials are available from various manufacturers and include those sold under the trade names, SARTOMER, EBECRYL, and PHOTOMER.

In a non-limiting embodiment of the present invention, an adhesion-enhancing amount of at least one adhesion promoting material (adhesion promoter) may be incorporated into the curable composition comprising the transparent polymeric tie layer. By adhesion-enhancing amount is meant that the compatibility of the further transparent polymeric layer to a superimposed organo silane-containing abrasion-resistant coating (as described herein) is enhanced. In one non-limiting embodiment, from 0.1 to 20 weight percent of at least one adhesion promoter(s) may be incorporated into the coating composition comprising the further transparent polymeric layer prior to applying it to the cross-linked polyhydroxy film. In alternate non-limiting embodiments, from 0.5 to 16, e.g., 0.5 to 10, weight percent, such as from 0.5 to 8, e.g., 5, weight percent, of at least one adhesion promoter may be incorporated into the further organic polymeric layer. The amount of adhesion promoter incorporated into the further transparent polymeric layer may range between any combination of the aforestated values, inclusive of the recited values.

Adhesion promoting materials that may be incorporated into the transparent polymeric tie layer include, but are not limited to, adhesion promoting organo-silane materials, such as aminoorganosilanes and silane coupling agents, organic titanate coupling agents and organic zirconate coupling agents. In a non-limiting embodiment, adhesion promoters such as those disclosed in copending U.S. patent publication Serial No. 2004/0207809 A1 filed Mar. 4, 2004 by W. Blackburn et al and entitled “Photochromic Optical Article” may be used. Such disclosure is incorporated herein by reference.

The composition comprising the further transparent polymeric tie layer can be prepared by mixing the components of the formulation at room temperature, although mild heating may be used to facilitate mixing and blending. The formulation can then be applied to the cross-linked polyhydroxy film by the same procedures that have been described for applying the photochromic coating to the rigid substrate, e.g., spin coating and dip coating. The applied formulation may then cured by any appropriate method, e.g., thermally and/or exposure to UV radiation. Following for example UV curing, a thermal post cure may be used to cure completely the polymeric tie layer. In a non-limiting embodiment, the polymeric layer may be heated in an oven at 212° F. (100° C.) for from 0.5 to 3 hours.

The further transparent polymeric tie layer may range in thickness from 2 to 20 microns. In alternate non-limiting embodiments, the thickness of the further transparent polymeric tie layer may range from 2 to 15 microns, e.g., from 8 to 12 microns. The thickness of the tie layer may range between any combinations of such values, inclusive of the recited values.

Photochromic articles of the present invention comprising a rigid substrate, photochromic organic polymeric coating, unstretched cross-linked polyhydroxy polymer coating/film and layer of transparent further organic polymer may be used in a variety of applications. In alternate non-limiting embodiments, the photochromic articles may be designed for use on transparent, e.g., optical, plastic substrates intended for ophthalmic applications, such as plano and vision correcting lenses, sun lenses and goggles, commercial and residential windows, automotive and aircraft transparencies, helmets, clear films, etc. Further, the photochromic articles of the present invention may be used in association with plastic films and sheets, optical devices, e.g., optical switches, display devices and memory storage devices, such as those described in U.S. Pat. No. 6,589,452, and security elements, such as optically-readable data media, e.g., those described in U.S. Patent Application 2002/0142248, security elements in the form of threads or strips, as described in U.S. Pat. No. 6,474,695, and security elements in the form of verification marks that can be placed on security documents and articles of manufacture.

In one non-limiting embodiment of the present invention, an abrasion-resistant coating is superposed, e.g., superimposed, on the further transparent organic polymeric layer. In such an embodiment, a post thermal cure (if used) may be postponed until after application of the abrasion-resistant coating if there is no significant physical handling of the product until after application of the abrasion-resistant coating. If such extensive handling is required, a thermal post cure may be performed prior to application of the abrasion-resistant coating.

Scratch resistance of polymer layers may be measured by conventional steel wool scratch tests known to those skilled in the art. This test measures the average haze gain of a surface subjected to abrasion by very fine steel wool. In accordance a non-limiting embodiment of the present invention, the average haze gain of a polymer layer providing scratch resistance may be less than 20. In alternate non-limiting embodiments, the average haze gain of a polymer providing scratch resistance may be less than 15, such as less than 10, e.g., less than 8. An Eberbach Steel Wool Abrasion Tester may be used to determine surface scratch resistance. A Bayer Abrasion Tester may also be used to determine surface abrasion resistance.

In a non-limiting embodiment, the further transparent polymeric layer will adhere firmly to the unstretched cross-linked polyhydroxy coating/film applied to the photochromic coating. Adhesion may be determined by the conventional art recognized crosshatch tape peel adhesion test, and/or by a boiling water crosshatch tape peel adhesion test, which is a more stringent test. The former is often referred to in the art as the primary (1°) test or dry test; while the later is often referred to as the secondary (2°) or wet test.

In a further non-limiting embodiment, the further transparent polymeric tie layer may be resistant to removal by aqueous inorganic caustic solutions, e.g., relatively dilute alkali metal hydroxide solutions, such as solutions of sodium hydroxide or potassium hydroxide. The polymer layer is considered to be resistant to removal by such solutions if the thickness of the polymer layer is reduced by not more than 0.5 microns after exposure to 12.5% aqueous potassium hydroxide at 140° F. (60° C.) for four minutes. In alternate non-limiting embodiments, the thickness of the polymer layer is not reduced by more than 0.5 microns after two exposures, e.g., after three exposures, to the aqueous potassium hydroxide solution.

In a non-limiting embodiment, the further transparent polymeric tie layer is compatible with organo silane-containing abrasion-resistant coatings used to protect plastic surfaces from abrasions, scratches, etc, which are appended to the further transparent polymeric tie layer. Organo silane abrasion-resistant coatings, often referred to as hard coatings or silicone-based hard coatings, are well known in the art, and are commercially available from various manufacturers, such as SDC Coatings, Inc. and PPG Industries, Inc. Non-limiting examples of organo silane hard coatings may be found in column 5, lines 1-45 of U.S. Pat. No. 4,756,973, and column 1, lines 58 through column 2, line 8, and column 3, line 52 through column 5, line 50 of U.S. Pat. No. 5,462,806, which disclosures are incorporated herein by reference. See also the disclosures of organo silane hard coatings that are found in U.S. Pat. Nos. 4,731,264, 5,134,191, 5,231,156 and International Patent Publication WO 94/20581, the disclosures of which hard coatings are incorporated herein by reference.

While in one non-limiting embodiment, the further transparent polymeric layer is described as being compatible with organo silane hard coatings, other coatings that provide abrasion and scratch resistance, such as polyfunctional acrylic hard coatings, melamine-based hard coatings, urethane-based hard coatings, alkyd-based coatings, silica sol-based hard coatings or other organic or inorganic/organic hybrid hard coatings may be used as the abrasion-resistant coating.

One skilled in the art can readily determine if the further transparent polymeric layer is compatible with organo silane hard coatings by applying an organo silane hard coat to the further transparent polymeric layer and determining its compatibility to that hard coat by means of the cross-hatch tape peel adhesion test (described hereinbefore), that is performed on the hard coat. Another method of determining compatibility of the further transparent polymeric layer to the hard coat is the absence of crazing in the hard coat after it has been applied to the further polymeric tie layer and cured. By crazing is meant the presence of fractures in the hard coat. Such fractures are sometimes readily apparent by observation; however, the fractures can be very fine and if so may be observable by magnification under bright light. The bright light may be a high intensity white arc light of a 75 watt Xenon bulb, with the light being projected vertically down through the hard coat.

By use of the term “compatible with an organo silane abrasion-resistant coating (hard coat)” is meant that the specified polymer layer is capable of having an organo silane hard coat deposited on its surface and that the organo silane hard coat adheres to the polymer layer under ordinary handling/wear conditions, as determined by the conventional crosshatch tape peel adhesion test, and/or the abrasion-resistant coating does not exhibit crazing after being applied and cured. Naturally, an organo silane hard coat can be removed by treatment with concentrated aqueous caustic, or by severe mechanical abrasion. Further, the term abrasion-resistant organo silane-containing coating (or other such similar meaning terms) is meant that the abrasion-resistant coating is prepared from a composition comprising at least one organo silane.

In one non-limiting embodiment, a primer coating, if required, is applied to the transparent further polymeric tie layer before applying the abrasion-resistant coating to it. Such primer coatings are known in the art. Selection of an appropriate primer coating will depend on the particular further polymeric layer and abrasion-resistant coating used. The primer coating may be one or several monomolecular layers thick, and may range from 0.1 to 10 microns, e.g., from 0.1 to 2 or 3 microns, in thickness. Such primer coatings are discussed herein in relation to the photochromic coating, and that discussion is applicable here also.

In one non-limiting embodiment, the organo silane hard coating may be prepared from a composition comprising from 35 to 95 weight percent, as calculated solids, of at least one organo silane monomer represented by the following empirical formula XI:
R¹SiW₃ XI

wherein R¹ can be glycidoxy(C₁-C₂₀)alkyl, desirably glycidoxy(C₁-C₁₀)alkyl, and most desirably, glycidoxy (C₁-C₄)alkyl; W can be hydrogen, halogen, hydroxy, C₁-C₅ alkoxy, C₁-C₅ alkoxy(C₁-C₅)alkoxy, C₁-C₄ acyloxy, phenoxy, C₁-C₃ alkylphenoxy, or C₁-C₃ alkoxyphenoxy, said halogen being bromo, chloro or fluoro. In a non-limiting embodiment, W is hydrogen, halogen, hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy, and the halogen is chloro or fluoro. In an alternate non-limiting embodiment, W is hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy.

In a non-limiting embodiment, the weight percent, as calculated solids, of the silane monomers represented by empirical formula XI in the hard coat composition range from 40 to 90 weight percent. In alternate non-limiting embodiments, the weight percent of the silane monomers ranges from 45 to 85, e.g., from 50 to 70, weight percent calculated solids. The weight percent calculated solids are determined as the percent of the silanol that theoretically forms during the hydrolysis of the orthosilicate.

Non-limiting examples of silane monomers represented by general formula XI include glycidoxymethyltriethoxysilane, glycidoxymethyltrimethoxysilane, alpha-glycidoxyethyltrimethoxysilane, alpha-glycidoxyethyltriethoxysilane, alpha-glycidoxypropyltrimethoxysilane, alpha-glycidoxypropyltriethoxysilane, alpha-glycidoxypropyltrimethoxysilane, alpha-glycidoxypropyltriethoxysilane, (their beta, gamma and delta analogues where applicable), hydrolyzates of such silane monomers, and mixtures of such silane monomers and hydrolyzates thereof.

The abrasion-resistant coating (hard coat) may be superposed on, e.g., applied to, the further transparent polymer tie layer using the same application techniques described with respect to the photochromic coating, e.g., spin coating. The thickness of the abrasion resistant film may range from 0.5 to 10 microns. Prior to applying the hard coating, e.g., the organo silane hard coat, to the further transparent polymeric layer, the polymeric layer may be treated to enhance its receptivity of and adhesion of the hard coat. Such treatments, e.g., plasma treatments, as are described herein with respect to pretreatment of the photochromic coating may be used.

In a further embodiment of the present invention, additional coatings, such as antireflective coatings, may be applied to the hard coat layer. Non-limiting examples of antireflective coatings are described in U.S. Pat. No. 6,175,450 and International Patent Publication WO 00/33111, which disclosures of antireflective coatings are incorporated herein by reference.

The present invention is more particularly described in the following example, which is intended as illustrative only, since numerous modifications and variations therein will be apparent to those skilled in the art. In the examples, percentages are reported as weight percent, unless otherwise specified. Materials, such as monomers, catalysts, initiators, etc.), which are identified by a lower case letter in parenthesis, are similarly identified in any subsequent disclosure.

In the following example, residual bleach colors (a*) and (b*) values are obtained by use of a Hunter Spectrophotometer and are expressed in Table 3 based on the CIELAB system. See column 7, lines 14-39 of U.S. Pat. No. 5,753,146 and pages 47-52 of Principles of Color Technology, by F. W. Billmeyer, Jr., and Max Saltzman, Second Edition, John Wiley and Sons, New York (1981) for a description of the CIELAB system. In this system, a* and b* describe color, a positive a* being red, a negative a* being green, a positive b* being yellow and a negative b* being blue. Y in Table 3 designates the initial transmittance of the test article.

### EXAMPLE

In the following example, plano PDQ coated polycarbonate lenses obtained from Gentex Cptics were used. The test lenses were treated with an oxygen plasma for 1 minute using a Plasmatech machine at a power setting of 100 Watts while introducing oxygen at a rate of 100 ml/min into the vacuum chamber of the Plasmatech machine.

A photochromic master batch was prepared by mixing 25.2 grams of N-methyl pyrrolidinone and 2.28 grams (total) of 4 different naphthopyran photochromic compounds on a stir plate at 60° C. until the photochromic compounds were dissolved. The photochromic compounds were chosen and used in a ratio that yielded a gray color when the blend was exposed to ultraviolet light. The master batch also contained 1.13 grams of Tinuvin 144 UV stabilizer (hindered amine light stabilizer available from Ciba-Geigy); 2.52 grams of A-187 coupling agent (γ-glycidoxypropyl trimethoxysilane available from OSi), and 0.04 grams of BYK-333 silicone surfactant (reported to be a polyether modified dimethyl polysiloxane copolymer available from BYK Chimie, USA.).

A photochromic polyurethane coating composition was prepared from the components and amounts tabulated in Table 1 and mixed with the photochromic master batch. The mixture of the coating composition components were mixed for 60 minutes on a stir plate at room temperature before being applied to the plasma treated lenses by spin coating. The photochromic polyurethane coatings applied to the test lenses were thermally cured at 140° C. for 90 minutes in a convection oven. The photochromic polyurethane coatings were approximately 20 microns thick. One photochromic polyurethane coated lens was set aside (Sample E in Table 3) to serve as a performance reference.

TABLE 1
Formulation

| Component/ | Grams |
|---|---|
| Desmodur PL 3175A (a) | 6.3 |
| Vestanat B 1358A (b) | 26.5 |
| PC 1122 (c) | 25.0 |
| HCS 6234 polyol (d) | 5.9 |
| Dibutyltin dilaurate | 0.5 |
| Photochromic Master batch (e) | 31.2 |

(a) Methyl ethyl ketoxime blocked hexamethylene diisocyanate (Bayer)
(b) Methyl ethyl ketoxime blocked isophorone diisocyanate trimer (CreaNova, Inc.)
(c) Polyhexane carbonate diol (Stahl)
(d) Polyacrylate polyol (Composition D in Example 1 of US. Pat. No. 6,187,444 B1)
(e) A mixture in NMP of naphthopyran photochromic materials chosen to produce a gray tint when exposed to UV light.

One hundred (100) grams of distilled water was added to a wide-mouth jar and the jar placed in a triethylene glycol bath that was stirred magnetically and heated on a hot plate. The water was agitated vigorously with a Brookfield Counter Rotating Stirrer and 5.25 grams of Celvol 325 poly(vinyl alcohol) [available from Celanese] was added to the water. The temperature of the triethylene glycol bath was raised to 90° C. and the water/PVA mixture stirred vigorously for 30 minutes to form a clear solution. The jar containing the PVA solution was removed from the glycol bath and the solution allowed to cool to room temperature.

Three test solutions, each containing 10 grams of the PVA solution and a cross-linking agent, were prepared. Sample A contained 0.42 grams of Polycup® 172 cross-linking resin (a water-soluble polyamide-epichlorohydrin resin available from Hercules, Inc.); Sample B contained 0.14 grams of Polycup® 1884 cross-linking resin (a water-soluble polyamide-epichlorohydrin resin available from Hercules, Inc.); and Sample C contained 0.13 grams of glyoxal (CAS 107-22-2).

Photochromic polyurethane coated test lenses were treated with an oxygen plasma for 1 minute using a Plasmatech machine at a power setting of 100 Watts while introducing oxygen at a rate of 100 ml/min into the vacuum chamber of the Plasmatech machine, and then separate test lenses were coated with one of the PVA test solutions by spin coating to obtain a wet film weight of approximately 0.025 grams. The PVA coated lenses were dried under an IR (infrared) lamp for 10 minutes. The IR lamp was placed at a distance from the lenses so that the temperature of the coating did not exceed 100° C.

The PVA coated lenses were then coated with an organic polymer tie layer prepared from the components tabulated in Table 2. The tie layers were applied by spin coating. The tie layer coatings had an approximate wet film weight of 0.05 grams, were cured in a nitrogen atmosphere with UV light from a D bulb, and then post cured for 3 hours at 100° C. in a convection oven.

One set of PVA/tie layer coated test lenses was tested for adhesion by use of the primary and secondary crosshatch tape peel adhesion tests, and all samples passed this test. A second set of such lenses was tested for transmittance, residual bleach color, activated density and fading half-lives. Residual bleach color values were obtained using a Hunter Spectrophotometer and fade rate values were obtained using an optical bench. Photochromic migration is evidenced by an increase in the fade rate value, particularly the 3T ½ value. The data for photochromic response and fade rate tests is tabulated in Table 3. In this table, Sample D is a photochromic polyurethane coated lens that does not contain a PVA film coating, but has the tie layer coating. Sample E is the photochromic polyurethane coated lens that has no PVA coating or tie layer polymer coating, which was set aside to serve as a performance reference.

TABLE 2
Formulation

| Component/ | Grams |
|---|---|
| SR-399 (f) | 5.0 |
| BPA 2EO DMA (g) | 35.0 |
| TMPTMA (h) | 30.0 |
| ADME #302 (i) | 30.0 |
| BAPO (j) | 0.1 |
| A-187 (k) | 20.0 |
| CD-1011 (l) | 4.0 |

(f) Dipentaerythritol pentaacrylate (Sartomer)
(g) Bisphenol A (2EO) Dimethacrylate (Sartomer)
(h) Trimethylolpropane Trimethacrylate (Sartomer)
(i) Methacrylated Bisphenol A Epoxide (Echo Resins and Laboratory, Versailles, MO.)
(j) Bis(2,4,6-trimethyl benzoyl) phenyl phosphine oxide (Ciba Geigy)
(k) (γ-glycidoxypropyl trimethoxysilane available from OSi)
(l) Triarylsulfonium hexafluorophosphate salts mixed 50% in propylene carbonate (Sigma Aldrich)

TABLE 3

| | Initial Values¹ | | | Photopic | Fade Rate³ | | |
|---|---|---|---|---|---|---|---|
| Sample | Y | a* | b* | ΔOD² | T½ | 2T½ | 3T½ |
| A | 87.5 | −1.1 | 3.5 | 0.818 | 75 | 231 | 478 |
| B | 88.0 | −1.1 | 3.4 | 0.816 | 77 | 231 | 472 |
| C | 87.8 | −1.1 | 3.5 | 0.819 | 78 | 233 | 465 |
| D | 86.5 | −1.1 | 3.1 | 0.821 | 83 | 256 | 528 |
| E | 88.1 | −0.9 | 2.6 | 0.855 | 79 | 236 | 479 |
| ¹Initial transmittance (Y) and color (a* and b*) values. | | | | | | | |
| ²Change in optical density when exposed to UV light. | | | | | | | |
| ³The fade rates (in seconds) after activation at 72° F. (22° C.) for the lens to reach ½ the highest ΔOD | | | | | | | |
| # (T½); for the lens to reach ½ of the interval between the ½ OD | | | | | | | |
| # level and the highest ΔOD (2T½); and for the lens to reach ½ of the interval between the 2T½ OD | | | | | | | |
| # level and the highest ΔOD (3T½) after removal of the source of activating light | | | | | | | |

The data of Table 3 show that the lenses with the cross-linked PVA film coating (Samples A, B and C) exhibit similar fading values to the performance reference lens (Sample E); while the lens without the cross-linked PVA film (Sample D) shows significantly higher fading values, particularly for the 2T½ and 3T 1/2 values, which indicates slower photochromic fading and photochromic migration into the polymeric tie layer.

Although the present invention has been described with reference to specific details of certain embodiments thereof, it is not intended that such details should be regarded as limitations upon the scope of the invention except insofar as they are included in the accompanying claims.

What is claimed is:

1. A photochromic article comprising:
(a) a rigid substrate,
(b) a photochromic organic polymeric coating appended to at least a portion of at least one surface of said substrate, said photochromic coating comprising a photochromic amount of at least one photochromic material,
(c) a film comprising unstretched cross-linked polyhydroxy polymer appended to said photochromic organic polymeric coating, and
(d) a layer of transparent further organic polymer that is superposed on said film comprising cross-linked polyhydroxy polymer.

2. The photochromic article of claim 1 wherein the polyhydroxy polymer is a natural, chemically modified natural or synthetic polyhydroxy polymer.

3. The photochromic article of claim 2 wherein the polyhydroxy polymer is poly(vinyl alcohol).

4. The photochromic article of claim 1 wherein the film comprising the cross-linked polyhydroxy polymer has a thickness of from 0.1 to 10 microns.

5. The photochromic article of claim 1 wherein an abrasion resistant coating is appended to the further organic polymer layer.

6. The photochromic article of claim 5 wherein the abrasion resistant coating is an organo silane-based abrasion resistant coating.

7. The photochromic article of claim 1 wherein the transparent rigid substrate is an organic polymeric substrate chosen from thermoset or thermoplastic materials having a refractive index of from 1.48 to 1.74.

8. The photochromic article of claim 7 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes or substrates prepared from compositions comprising the reaction product of polyfunctional isocyanate(s) and/or isothiocyanate(s) with polythiol(s) or polyepisulfide monomer(s).

9. The photochromic article of claim 8 wherein the allyl diglycol carbonate is diethylene glycol bis(allyl carbonate).

10. The photochromic article of claim 1 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, or photochromic epoxy resin-based coatings.

11. The photochromic article of claim 1 wherein the photochromic material is an organic photochromic material chosen from photochromic spirooxazines, benzopyrans, naphthopyrans, fulgides, metal dithizonates, diarylethenes or mixtures of such photochromic materials.

12. The photochromic article of claim 11 wherein the photochromic naphthopyran is chosen from naphtho[1,2-b]pyrans, naphtho[2,1-b]pyrans, spiro-9-fluoreno[1,2-b]pyrans, phenanthropyrans, quinopyrans or indeno-fused naphthopyrans, and the spirooxazine is chosen from naphthoxazines or spiro (indoline)pyridobenzoxazines.

13. The photochromic article of claim 5 wherein the photochromic article is a lens.

14. A photochromic article comprising:
(a) a rigid transparent substrate,
(b) a photochromic organic polymeric coating appended to at least a portion of said substrate, said photochromic coating comprising a photochromic amount of at least one organic photochromic material,
(c) a non-polarizing coating comprising unstretched cross-linked polyhydroxy polymer appended to said photochromic organic polymeric coating, and
(d) a layer of a transparent further organic polymer that is appended to said coating comprising cross-linked polyhydroxy polymer.

15. The photochromic article of claim 14 wherein the synthetic polyhydroxy polymer is chosen from poly(vinyl alcohol), or polymers prepared from polymerizable compositions comprising the materials 2-hydroxyethyl methacrylate, 2-hydroxypropyl acrylate, 2-hydroxypropyl methacrylate, 2,4-dihydroxy-4-vinyl benzophenone, N-2-hydroxyethyl acrylamide, N-2-hydroxyethyl methacrylamide and mixtures of such materials.

16. The photochromic article of claim 15 wherein the degree of hydrolysis of the poly(vinyl alcohol) ranges from 75 to 99.8 percent.

17. A photochromic article comprising:
(a) a rigid transparent substrate, said substrate being an organic polymeric substrate chosen from thermoset or thermoplastic materials, said substrate having a refractive index of from 1.48 to 1.74,
(b) a photochromic organic polymeric coating appended to at least a portion of said substrate, said photochromic coating comprising a photochromic amount of at least one organic photochromic material,
(c) a coating comprising unstretched cross-linked polyhydroxy polymer appended to said photochromic organic polymeric coating, said cross-linked polyhydroxy polymer being substantially free of oriented polarizing material, and
(d) a layer comprising a transparent further organic thermoset polymer that is appended to said coating comprising cross-linked polyhydroxy polymer.

18. The photochromic article of claim 17 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes and substrates prepared from compositions comprising the reaction product of polyfunctional isocyanate(s) and/or isothiocyanates with polythiol or polyepisulfide monomer(s).

19. The photochromic article of claim 18 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, or photochromic epoxy resin-based coatings.

20. The photochromic article of claim 19 wherein the transparent further organic polymeric layer (d) is a radiation cured acrylic-based polymer.

21. The photochromic article of claim 20 wherein an abrasion resistant coating is appended to the transparent further organic polymer layer (d).

22. The photochromic article of claim 21 wherein the abrasion resistant coating is an organo silane-based abrasion resistant coating.

23. The photochromic article of claim 21 wherein the article is a lens.
